(19) United States
(12) Patent Application Publication
(10) Pub. No.: US 2023/0349568 A1
(43) Pub. Date: Nov. 2, 2023

(54) ENERGY SAVING CONDITIONER AND HEAT SUPPLY METHOD

(71) Applicant: Thinh Quoc Nguyen, Nam Dinh providence (VN)

(72) Inventors: Thinh Quoc Nguyen, Nam Dinh providence (VN); Lam Thanh Doan, Thai Binh province (VN)

(21) Appl. No.: 17/801,330

(22) PCT Filed: Nov. 12, 2020
(86) PCT No.: PCT/VN2020/000009

§ 371 Date: Aug. 22, 2022

(30) Foreign Application Priority Data
Feb. 27, 2020 (VN) 1-2020-01069

(51) Int. Cl. F24F 5/00; F24T 10/10

(52) U.S. Cl. CPC F24F 5/0046; F24T 10/10; F24F 2005/0057

(57) ABSTRACT

The present disclosure provides an air conditioner comprising: an indoor heat exchanger to exchange heat between underground water and indoor air; an outdoor heat exchanger to exchange heat between underground water and outdoor air; a well; an underground water tank to store underground water; and a water pump to pump water from the well to the underground water tank. The indoor heat exchanger comprises a copper tube running through a row of parallel aluminum panels. Air is sucked by a fan through the indoor heat exchanger in the direction opposite to the underground water flow direction in the copper tube. Air is then passed through an evaporator unit of a compressor to be dehumidified. The underground water, after exchanging heat with the air to reach approximate room temperature, goes through a condensing unit of the compressor to release heat.

### CROSS REFERENCE TO RELATED APPLICATIONS

This application is a U.S. national stage application, filed under 35 U.S.C. § 371, of International Application No. PCT/VN2020/000009, which was filed on Nov. 12, 2020, and which claims priority to Vietnamese Patent Application No. 1-2020-01069, which was filed on Feb. 27, 2020. The contents of each are hereby incorporated by reference into this specification.

### TECHNICAL FIELD

The invention refers to an air conditioner using underground water.

### DESCRIPTION OF THE RELATED ART

Common air conditioning and heating techniques consume a lot of energy and geothermal exchange techniques for air heating and cooling are still low energy efficient, instability, cumbersome, and costly in terms of equipment.

### BRIEF SUMMARY OF THE INVENTION

The present invention provides an air conditioner using underground water for air conditioning based on climate. This air conditioner is applicable to climates where there is a significant temperature difference between summer and winter.

Usually, the temperature of underground water in each region is quite stable for the whole year according to the climate and approximately of the annual average temperature in that region. The air conditioner according to the present invention can actively adjust a part of underground water temperature according to climate with specific conditioning needs by calculating the heat load needed for air conditioning, calculating the heat load released or absorbed by underground water in summer and winter, calculating distance and volume of the well and distance for releasing water to the ground.

Depending on the climate and the needs for conditioning, there is provided two modes of temperature regulation. For the subtropical climate (where the underground water temperature is around 17-27° C.), underground water absorbs heat from the air that needs conditioning. For where at low annual average temperatures, underground water supplies heat to the air that needs conditioning. These modes of air conditioning take advantage of the great heat capacity of water, which is 4.18 J/g° C.

### BRIEF DESCRIPTION OF THE DRAWINGS

FIG. 1 shows an air conditioning cycle by using underground water in subtropical climate.

FIG. 2 shows an air conditioning cycle by using underground water in subtropical climate with two separate wells, one for storing heated water and one for storing cooled water.

FIG. 3 is a graph showing the change of temperature of the air and underground water during heat exchanging process.

FIG. 4 shows a heat exchanger according to the present invention.

FIG. 5 shows an air conditioning cycle for low temperature zones, with underground water serving as the heat source for a heat pump.

FIG. 6 shows the process of using underground water to make hot water according to the present invention.

### LIST OF REFERENCE

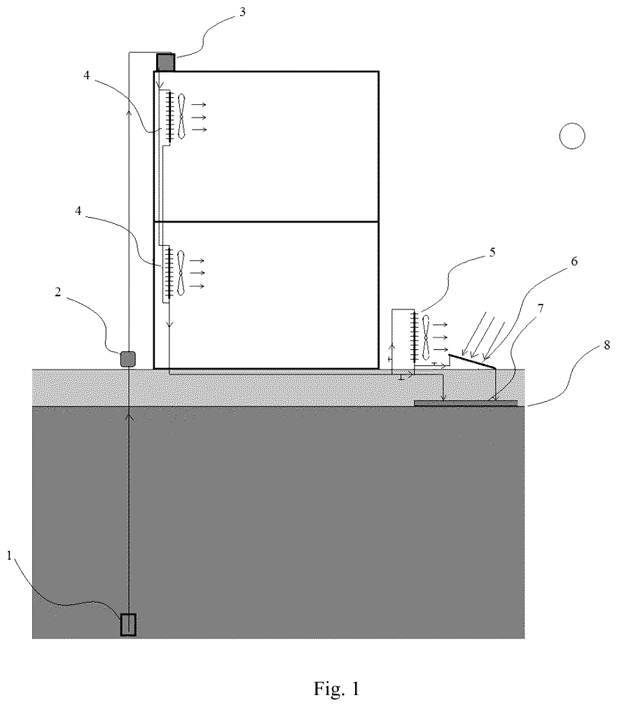

FIG. 1:

(1): Well
(2): Water pump
(3): Underground water tank
(4): Air-water heat exchanger
(5): Outdoor heat exchanger
(6): Solar collector
(7): Sand layer to absorb and return water to the underground
(8): Ground water level

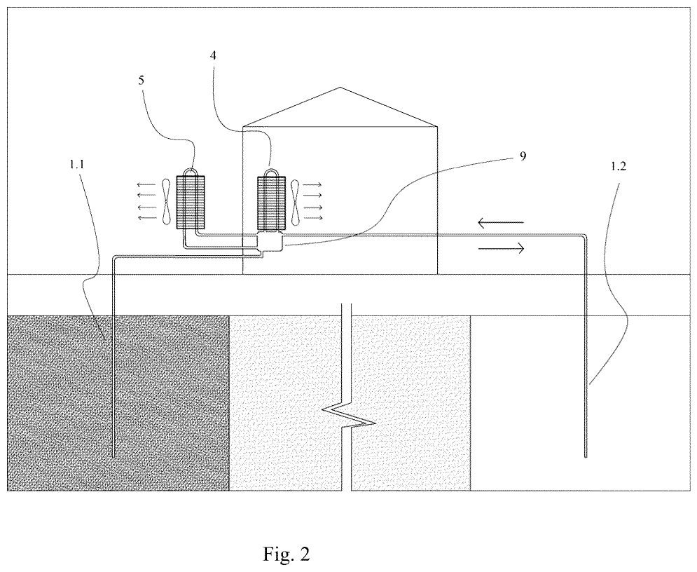

FIG. 2:
(1.1): Cold well
(1.2): Hot well
(9): 4-way water valve

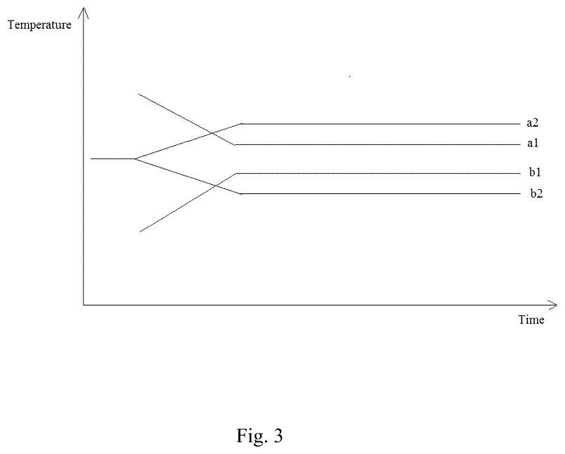

FIG. 3:
(a1): Temperature of air after exchanging heat with cooling underground water.
(a2): Temperature of cooling underground water.
(b1): Temperature of air after exchanging heat with heating underground water.
(b2): Temperature of heating underground water.

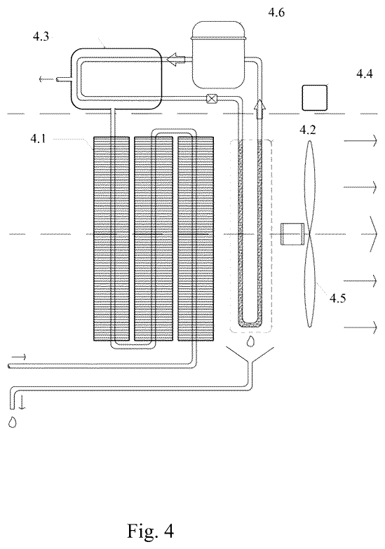

FIG. 4:
(4.1): Underground water-air heat exchanger
(4.2): Small evaporator unit for moisture removal
(4.3): Small condensing unit with underground water as heat collector
(4.4): Controller
(4.5): Fan/Blower
(4.6): Small compressors unit

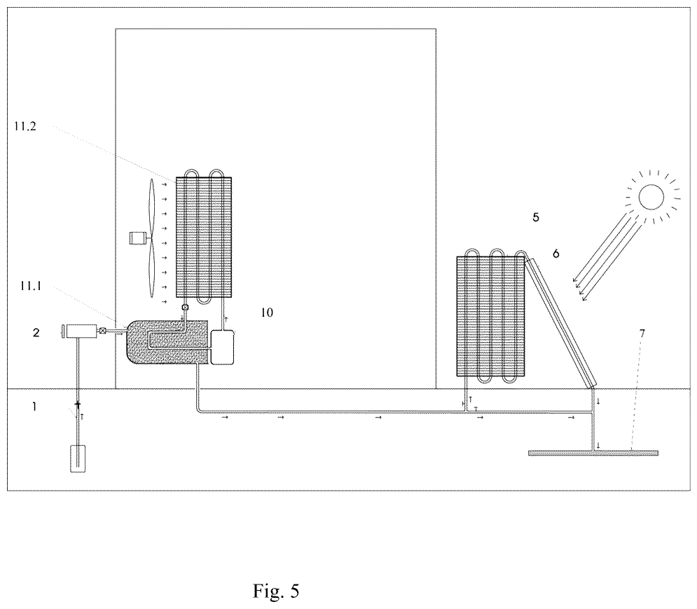

FIG. 5:
(10): Heat pump
(11.1): Evaporator unit
(11.2): Condensing unit

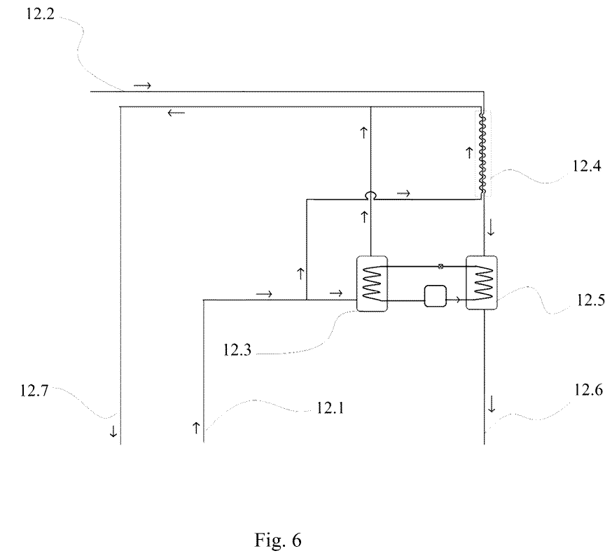

FIG. 6:
(12.1): Underground water supply pipe
(12.2): Pipe for supplying water to be heated
(12.3): Evaporator unit of the heat pump
(12.4): Countercurrent heat exchanger for underground water and water needs to be heated
(12.5): Condensing unit
(12.6): Hot water supply pipe
(12.7): Underground water drainage pipe

### DETAILED DESCRIPTION OF THE INVENTION

An air conditioning cycle for subtropical climates, where the annual average temperature is around 17-27° C. (where underground water temperature could be maintained at 19-25° C. by absorbing from the environment in summer or releasing heat to the environment in winter), is performed by using an air-water heat exchanger that exchanges heat between underground water and air. Outlet water then can further exchange heat with the environment depending on the seasons (summer or winter), local climates or the required conditioning temperatures so that cooled or heated water can be returned into the underground for future usage.

As shown in FIG. 1: In summer, underground water is pumped by water pump 2 from well 1 to underground water tank 3 (with an anti full relay). Underground water from this tank flows down to heat exchanger 4 to condition room temperature. Underground water, after of the conditioning process, flows out to outdoor heat exchanger 5 (if it is needed to absorb more heat from the environment in summer) and then returns to the underground through a sand layer 7. In winter, underground water also flows down to indoor heat exchanger 4 to warm up indoor air, then flows down to outdoor heat exchanger 5 to release heat to become cooler, then flows down to sand layer 7 to return to the underground. In case it is not required to warm up room temperature in winter, underground water can still be pumped following this procedure to be cooled down and to compensate for the heat being taken away during air conditioning process in summer. The method of air conditioning by using underground water according to the present invention only consumes 10% to 15% of energy of common air conditioners.

For example: For the climate in Northern Vietnam, the annual average temperature is 24-25° C., the underground water temperature is also 24-25° C. By returning cooled water in the winter into the underground, the method of the present invention can cool down and maintain the temperature of underground water at about 22-23° C.

Assuming the underground water temperature is 23° C., the range of temperature change of both underground water and air is dT, m_{water} is the mass of water, man is the mass of air, C_{water} (4.18 KJ/Kg.K) is the heat capacity of water, Can (1.1 KJ/Kg.K) is the heat capacity of air.

Equation of heat exchange of underground water and air:

Cooling process:Heat absorbed by water(Q water)=Heat released by air(Q air)

Warming process:Heat released by water(Q water)=Heat absorbed by air(Q air)

m_{water}.C_{water}.dT=mₐᵢᵣ.Cₐᵢᵣ.dT

[symbol]

m_{water}.4.18=mₐᵢᵣ1.1

[symbol]

m_{water}/0.263=mₐᵢᵣ

As a result, each liter of underground water at 23° C. produces about three cubic meters of air at 23.5-24° C. in cooling process or at 22-22.5° C. in warming process, as long as underground water is at approximately room temperature after the heat exchanging process. For a room of about 15 m² that is pre-shading and pre-sealed, the conditioning process needs water flow of about 1-1.5 liters per minute.

Where the annual average temperature or the underground water temperature is of 17-20° C., the conditioning process is similar, but in summer after the air conditioning process, underground water needs to absorb more heat through outdoor heat exchanger 5, then in winter underground water is just used to warm up indoor air without releasing heat at outdoor heat exchanger 5.

The heat exchanging step at outdoor can also be based on the high or low of dew point of the weather. The heat exchanging process at outdoor can be more boosted by exposing outdoor heat exchanger 5 to the environment so as to receive condensed water to increase temperature, or to let condensed water evaporate to reduce temperature.

If land area is large enough, the efficiency of the conditioning method according to the present invention can be improved by using two wells, one for hot underground water and the other for cold underground water as illustrated in FIG. 2. Accordingly, in an air cooling process in summer, cold underground water is pumped from cold well 1.1 to 4-way valve 9 to enter indoor heat exchanger 4 to cool down indoor air, then underground water flows to outdoor heat exchanger 5 to absorb more heat from the environment, and underground water flows to 4-way valve 9 before being poured into hot well 1.2. In an air warming process in winter, warm underground water is pumped from hot well 1.2 to 4-way valve 9 to indoor heat exchanger 4 to warm up indoor air, then underground water flows to outdoor heat exchanger 5 to release more heat to the environment, then underground water flows to 4-way valve 9 before being poured into cold well 1.1 to complete an one-year cycle.

The method of air conditioning by exchanging between underground water and indoor air can be affected by a number of factors, such as environment temperature, humidity of the air, wind speed. Therefore, the method can be combined with other steps such as moisture separation, shielding from the sun and wind. FIG. 3 is a graph that shows the air temperature after exchanging heat for cooling or warming.

The heat exchangers can be composed of at least at a copper tube that runs through two row of parallel aluminum panels so that underground water and air can pass through in opposite directions. In FIG. 4, three the heat exchanger 4.1 are coupled together. In summer, air is sucked by a fan 4.5 through indoor heat exchanger 4.1 in the direction opposite to the underground water flow direction; the air then passes through evaporator unit 4.2 of a small compressing capacity to dehumidify the air supplied to the room. Underground water, after exchanging heat with the air to reach approximate room temperature, goes through the condensing unit 4.3 of compressor release heat. A controller 4.4 to control fan 4.5, wind direction, water rate, dehumidification process to regulate the room humidity at 60-70% or to make the dew point of the room lower than the underground water temperature, etc. The warming process in winter is similar to the process in summer, however there is no need to dehumidify the air.

In regions where annual average temperatures (underground water temperatures) are equal or below 17° C., where it is mainly need to warm up in winter but the underground water temperature is not high enough, a heat pump can be attached to provide an efficiency that is significantly higher than the current modes of geothermal heat exchanging. As illustrated in FIG. 5, in winter, underground water is pumped to supply heat to the evaporator unit 11.1 of a heat pump 10, heat at condensing unit 11.2 is released by a fan, underground water gets colder thereafter (but its temperature is still higher than freezing point), then underground water is released to the underground via sand layer 7. In summer, underground water is pumped up to exchange heat with the air get cooler if required, then underground water flows to outdoor heat exchanger 5 to get heat from outdoor air, then to solar collector 6 (optional), and then to the underground via sand layer 7 to compensate for the heat released in winter and to complete an one-year cycle.

Equation at the heat pump:

|Q released at evaporator unit|=|Q absorbed at condensing unit|+A

A: the electrical energy consumed by the heat pump.

Efficiency of this process ε

ε=η.Tₕₒₜ/(Tₕₒₜ−T_{cold})

ε(COP): Coefficient of performance according to Carnot theory

The value of η depends on the quality of the heat pump (usually η has a value of about 0.5)

Tₕₒₜ is the condensing temperature (° K).

T_{cold} is the evaporation temperature (° K).

To improve heat pump efficiency E, in addition to machine engineering technology, refrigerants, there are techniques that reduce the Tₕₒₜ-T_{cold} difference (reducing Tₕₒₜ, increasing T_{cold}, or simply making heat dissipation effective at both condenser and evaporator units).

For example: Applying the method of air conditioning according to the present invention in regions where the underground water temperature is 10° C.: The underground water exchanges heat at the evaporator unit at 2° C. (T_{cold}=275° K), the condensing unit is designed to have Tₕₒₜ=300° K (27° C.), the coefficient of performance:

ε≈0.5×300K/(300K−275K)=6

As a result, each 1 kWh of electricity supplied to the heat pump produces 6 kWh of thermal energy at 27° C. from condensing unit (underground water supplies 5 kWh of thermal energy to the heat pump).

In case fossil fuels are not used for direct warming, but are burned to generate electricity with an efficiency of 30% (the waste heat of burning fuel to generate electricity will be 70%). This amount of electricity is used for warming by this method, the amount of heat obtained: 6×30%+70%=250% (if including 70% of the waste heat from the fuel burning process for electricity generation).

The method according to the present invention can also use underground water as a heat source to make hot water. If the underground water temperature is high enough, it is possible to exchange heat between the water that needs to be heated and the underground water by a countercurrent heat exchanger 12.4, or a heat pump with groundwater can be used as the heat source. FIG. 6 shows the process of using underground water to make hot water. Wherein, the underground water is pumped via pipe 12.1 to supply heat to evaporator unit 12.3 of the heat pump, and pre-warm water from the countercurrent heat exchanger 12.4 enters condensing unit 12.5 to receive more heat to become hot water 12.6. Then, the heated underground water is cold down and returned to the underground through pipe 12.7.

For example, 100 liters of water at 15° C. is increased to 40° C. by using underground water at 24° C. as the heat source, and the heat pump is designed with a heating factor of 5 according to this heating method.

The thermal energy absorbed by water to be heated: (40-15)×4.18×100=10,450 kjun=2.9 kWh; Electricity consumed by heat pump to increase water temperature from 23° C. to 40° C.=17×4.18×100/(5×3600)=0.4 kWh.

1. (canceled)

2. An air conditioner using underground water comprising:
an indoor heat exchanger to exchange heat between underground water and indoor air;
an outdoor heat exchanger to exchange heat between underground water and outdoor air;
a well;
an underground water tank to store underground water;
a water pump to pump water from the well to the underground water tank;
wherein, the indoor heat exchanger comprises:
a copper tube running through a row of parallel aluminum panels;
wherein air is sucked by a fan through the indoor heat exchanger in a direction opposite to an underground water flow direction in the copper tube;
indoor air then passes through an evaporator unit of a compressor to be dehumidified; and
the underground water, after exchanging heat with the air to reach approximate room temperature, goes through a condensing unit of the compressor to release heat; and
a controller to control the fan, wind direction, water rate, and dehumidification process to regulate room humidity at 60-70%.

3. An air conditioner using underground water comprising:
a heat pump to warm up indoor air;
an outdoor heat exchanger to exchange heat between underground water and outdoor air;
a well;
a water pump to pump underground water from the well to an underground water tank;
wherein, underground water is pumped to supply heat to an evaporator unit of the heat pump, a fan is arranged to blow air to a condensing unit;
underground water from evaporator unit then is released to underground via a sand layer; and
in summer, underground water is pumped to the outdoor heat exchanger and a solar collector to get heat from outdoor air before being released to the underground via the sand layer.
